(19) United States
(12) Patent Application Publication
(10) Pub. No.: US 2024/0112545 A1
(43) Pub. Date: Apr. 4, 2024

(54) SYSTEMS AND METHODS FOR PERSISTENT COLLECTION AND EXTENDING SPINS

(71) Applicant: Aristocrat Technologies, Inc., Las Vegas, NV (US)

(72) Inventors: Daniel Marks, Decatur, GA (US); Hua Xu, Marietta, GA (US); John Milliner, III, Alpharetta, GA (US); Dinesh Dua, Alpharetta, GA (US); Sean Davis, Smyrna, GA (US)

(21) Appl. No.: 18/221,679

(22) Filed: Jul. 13, 2023

Related U.S. Application Data
(60) Provisional application No. 63/411,974, filed on Sep. 30, 2022.

(51) Int. Cl. G07F 17/32

(52) U.S. Cl. CPC G07F 17/3267; G07F 17/3213

(57) ABSTRACT

In one aspect, an electronic gaming system that includes at least one memory device with instructions stored thereon, and at least one processor in communication with the at least one memory device, wherein the instructions, when executed by the at least one processor, cause the at least one processor to display a game interface including a game matrix and generate a game outcome of a base game comprising a plurality of displayed symbols within the game matrix. The displayed symbols include at least a first symbol and a second symbol. If a wild symbol is displayed on a spin, a counter configured to track a number of displayed wild symbols over a predetermined period of time is incremented. If the number of counted wild symbols satisfies a threshold within the predetermined period of time, the second symbol is converted to or replaced by the first symbol.

### CROSS-REFERENCE TO RELATED APPLICATIONS

This application claims the benefit of priority to U.S. Provisional Patent Application No. 63/411,974, filed Sep. 30, 2022, entitled “SYSTEMS AND METHODS FOR PERSISTENT COLLECTION AND EXTENDING SPINS,” the entire contents and disclosure of which are hereby incorporated herein by reference.

### TECHNICAL FIELD

The field of disclosure relates generally to gaming devices, and more specifically, to systems and methods for extending the number of spins during a gaming instance, converting one symbol to another symbol, and activating additional rows of symbol positions.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system that includes at least one memory device with instructions stored thereon, and at least one processor in communication with the at least one memory device is provided. The instructions, when executed by the at least one processor, cause the at least one processor to display a game interface including a game matrix and generate a game outcome of a base game comprising a plurality of displayed symbols within the game matrix. The displayed symbols include at least a first symbol and a second symbol. If a wild symbol is displayed on a spin, a counter configured to track a number of displayed wild symbols over a predetermined period of time is incremented. If the number of counted wild symbols satisfies a threshold within the predetermined period of time, the second symbol is converted to or replaced by the first symbol.

In another aspect, a gaming system is provided. The gaming system includes at least one memory; and a processor configured to execute instructions stored in the memory. When executed, the instructions cause the processor to at least: cause to be displayed a game interface on a display device, the game interface including a game matrix having a plurality of symbol positions, each symbol position for displaying a symbol; generate a game outcome of a base game comprising a plurality of symbols displayed over a predetermined number of spins, each of the plurality of symbols displayed within a symbol position of the game matrix, the plurality of symbols comprising at least one first symbol and at least one second symbol, the at least one second symbol being different from the at least one first symbol; in response to a wild symbol being displayed as one of the plurality of symbols displayed from a spin input, increment a counter configured to count a number of wild symbols over the predetermined number of spins; and in response to a number of wild symbols counted over the predetermined number of spins satisfying a threshold, cause the at least one second symbol to be replaced with the at least one first symbol such that any displayed second symbols are changed to the first symbol.

In another aspect, a non-transitory computer-readable storage medium with instructions stored thereon is provided. In response to execution by at least one processor, the instructions cause the at least one processor to: cause to be displayed on a display device a game interface including a game matrix having a plurality of symbol positions for displaying a symbol within each symbol position; generate a game outcome of a base game comprising a plurality of symbols displayed over a predetermined number of spins, each of the plurality of symbols displayed within a symbol position of the game matrix, the plurality of symbols comprising at least one first symbol and at least one second symbol, the at least one second symbol being different from the at least one first symbol; in response to a wild symbol being displayed as one of the plurality of symbols displayed in response to a spin input, increment a counter configured to count a number of wild symbols displayed within any of the symbol positions of the game matric over the predetermined number of spins; and in response to a number of wild symbols counted over the predetermined number of spins satisfying a threshold, replace the at least one second symbol with the at least one first symbol.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4A is an example user interface or screenshot of a first example base game played on an EGM shown at FIG. 1, in which wild symbols are counted over a number of spins.

FIG. 4B is an example user interface or screenshot of the first example base game, in which a wild symbol counter is updated.

FIG. 4C is an example user interface or screenshot of the first example base game, in which one symbol is converted to another symbol.

FIG. 4D is an example user interface or screenshot of the first example base game, in which a coin symbol is counted.

FIG. 4E is an example user interface or screenshot of the first example base game, in which free extra spins are awarded.

FIG. 4F is an example user interface or screen shot of the first example base game with multiple players.

FIGS. 5A and 5B are a flowchart illustrating an example embodiment of a process for implementing a wagering game in which wild symbols are counted over a number of spins, as described with reference to FIGS. 4A-4F.

FIG. 6A is an example user interface or screenshot of a second example base game, in which wild symbols are counted over a number of spins.

FIG. 6B is an example user interface or screenshot of the second example base game, in which wild symbols are counted on a bonus matrix.

FIG. 6C is an example user interface or screenshot of the second example base game, in which one symbol is converted to another symbol.

FIG. 6D is an example user interface or screenshot of the second example base game, in which symbol positions within the bonus matrix become active.

FIG. 7A is an example user interface or screenshot of a third example base game, in which wild symbols are counted over a number of spins.

FIG. 7B is an example user interface or screenshot of the third example base game, in which wild symbols are counted on a bonus matrix.

FIG. 7C is an example user interface or screenshot of the third example base game, in which symbol positions within the bonus matrix become active.

FIG. 7D is an example user interface or screenshot of the third example base game, in which free extra spins are awarded.

FIG. 8 is a flowchart illustrating an example embodiment of a process for implementing a wagering game in which wild symbols are counted over a number of spins, as described with reference to FIGS. 6A-7D.

FIG. 9 is an example user interface or screenshot of the fourth example base game, according to an embodiment, in which one or more letters symbols are tracked over a plurality of spins.

### DETAILED DESCRIPTION

The present disclosure is directed to gaming devices, and more specifically, an electronic gaming system that includes at least one memory device with instructions stored thereon, and at least one processor in communication with the at least one memory device, wherein the instructions, when executed by the at least one processor, cause the at least one processor to display a game interface including a game matrix and generate a game outcome of a base game comprising a plurality of displayed symbols within the game matrix. The symbols being displayed after being initiated with an input on a spin button. If a wild symbol is displayed in response to a spin, a counter configured to track a number of displayed wild symbols over a predetermined period of time is incremented. If the number of counted wild symbols satisfies a threshold value within the predetermined period of time, a second predesignated symbol is then converted to the first symbol.

As wagering games become more complex, technical problems arise, including but not limited to, managing game presentation to users, increased computation resources, and slower computational speeds. A technical effect of the system and associated methods of the disclosure include at least one of: (i) increased variability for game presentation to users; (ii) increased variability for awards being granted to users; (iii) improved computational speed; (iv) conserving resources being used during a gaming instance; and (v) improving a user interface by displaying certain information to a user when having a limited display real estate for displaying information.

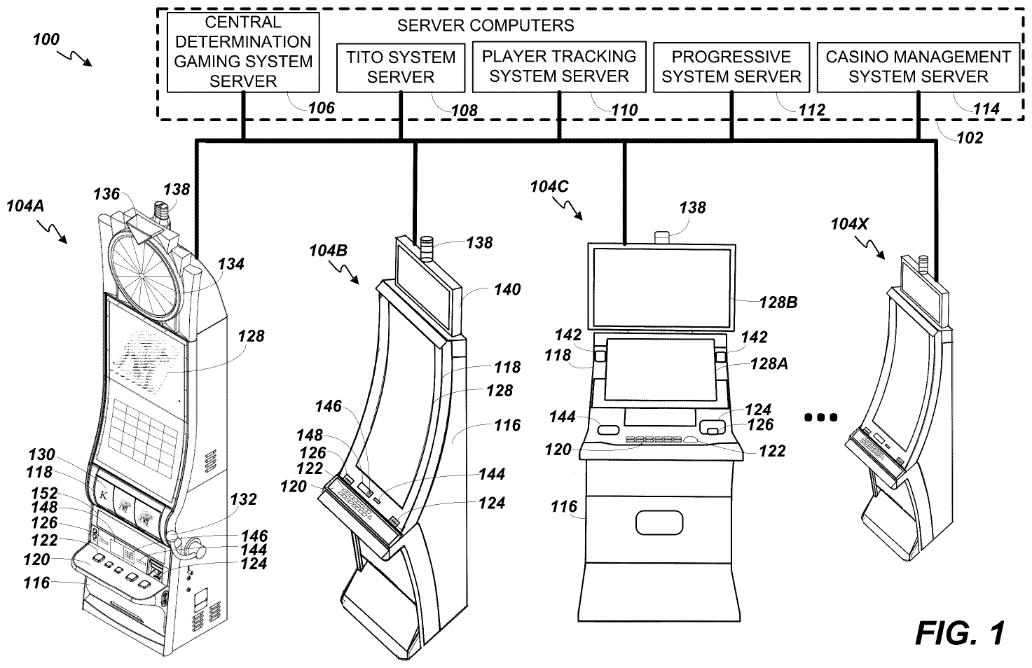

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

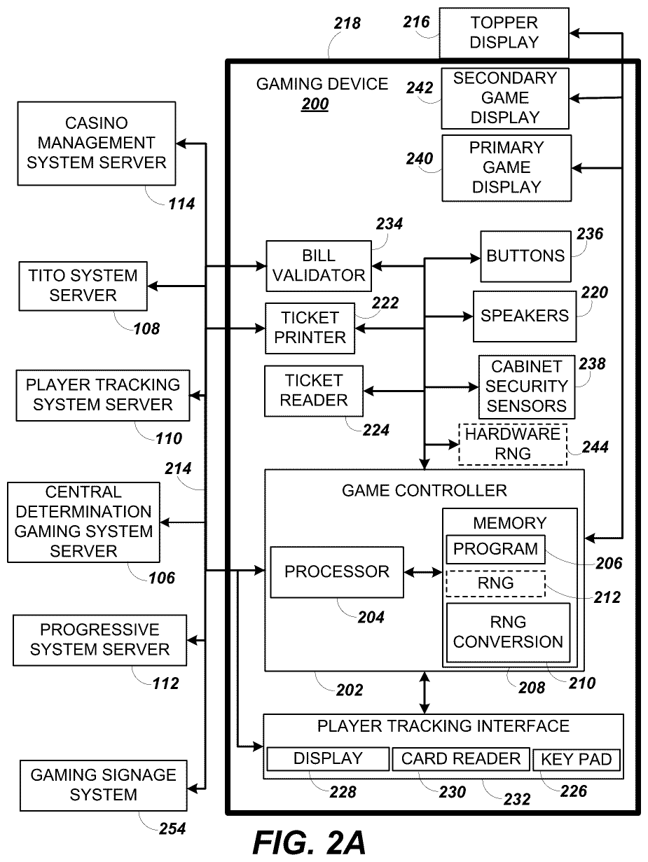

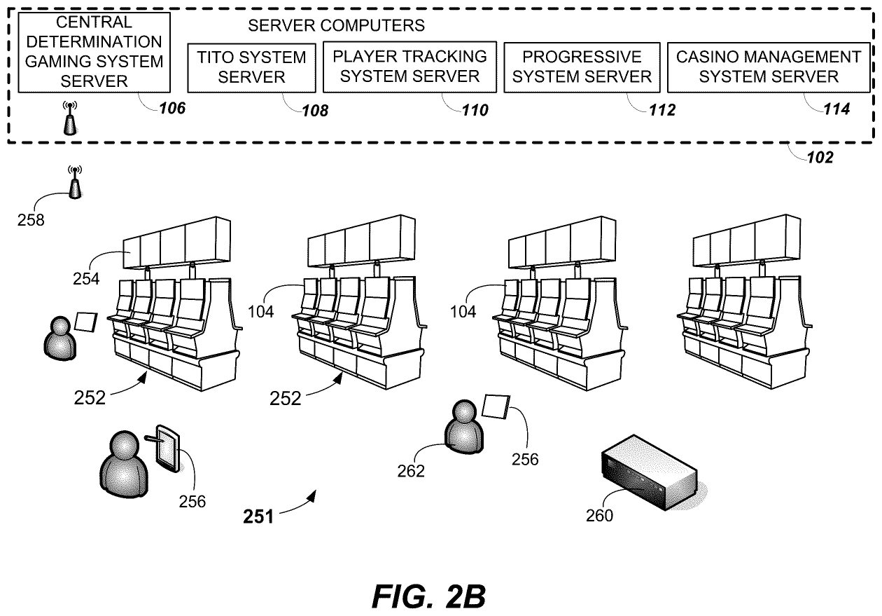

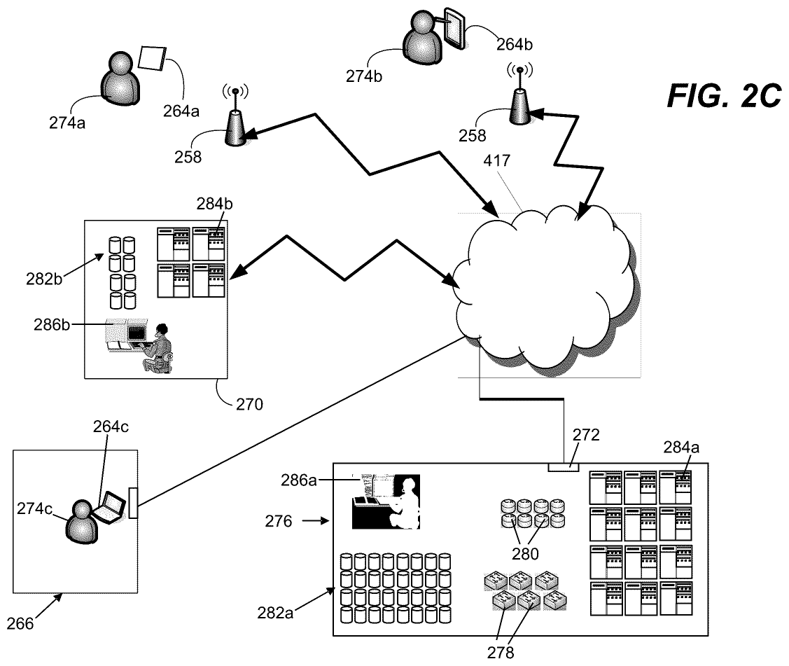

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of atop box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

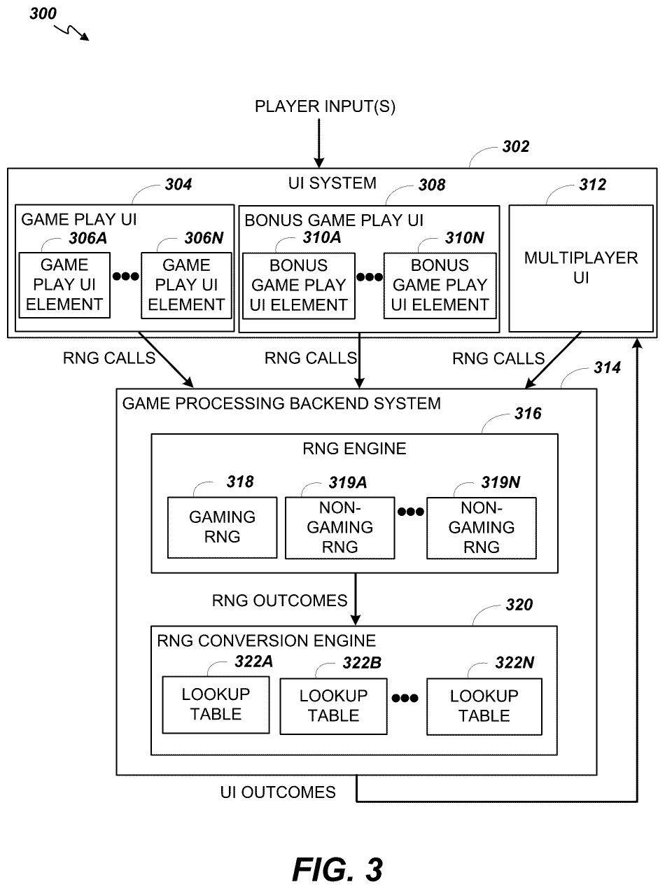

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could correspond to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

### Exemplary Gaming Instance—Counting Wild Symbols to Extend Number of Spins

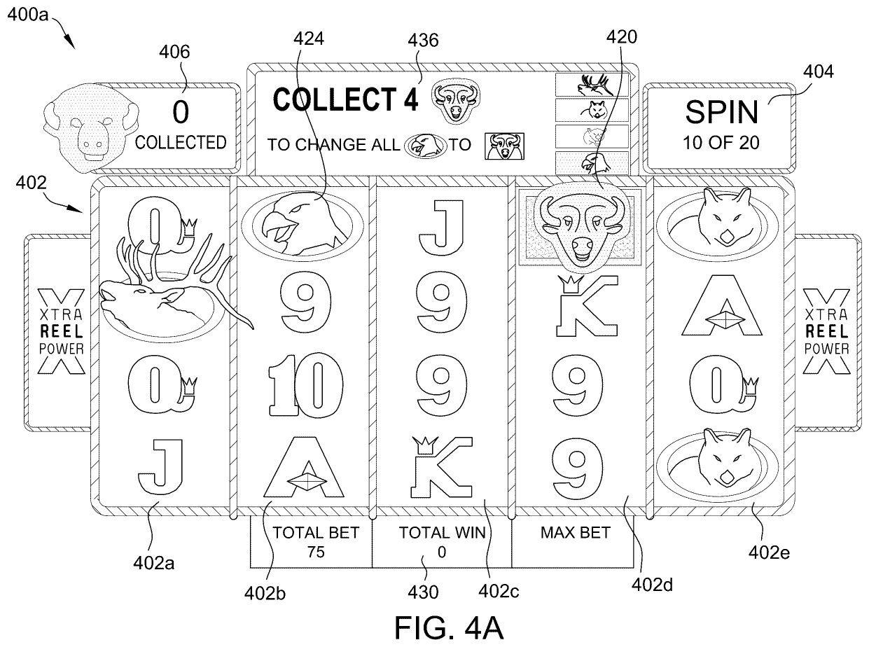

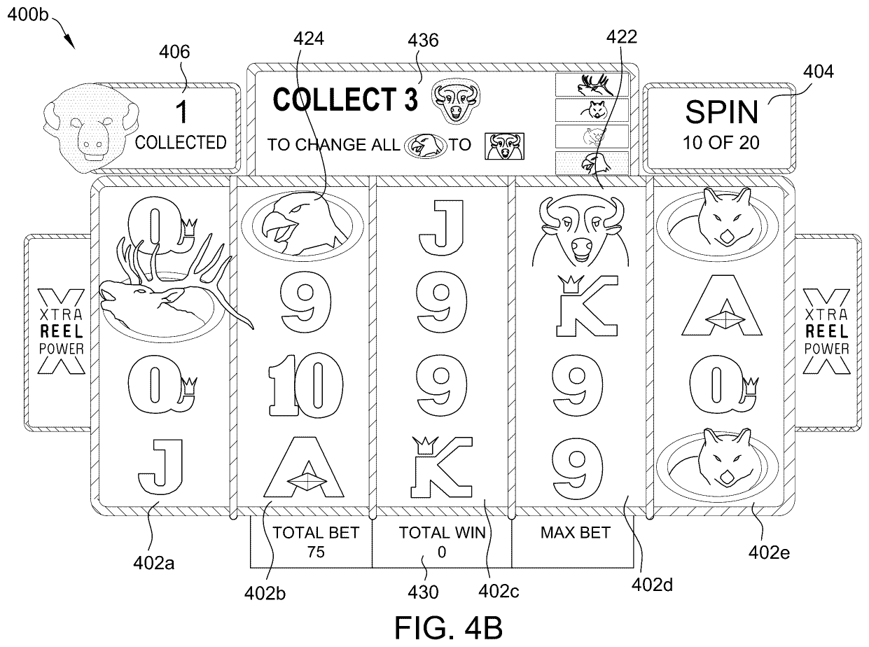

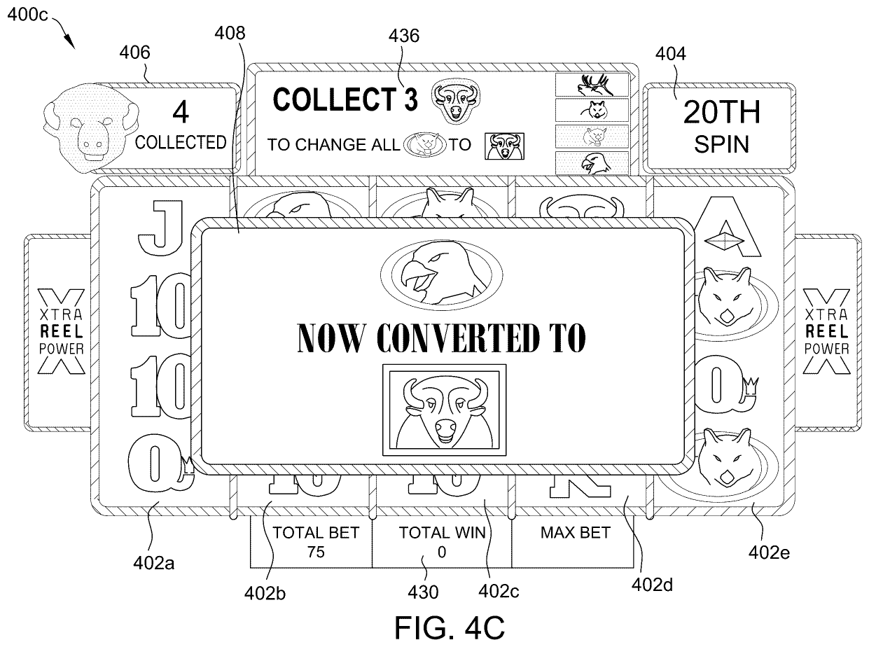

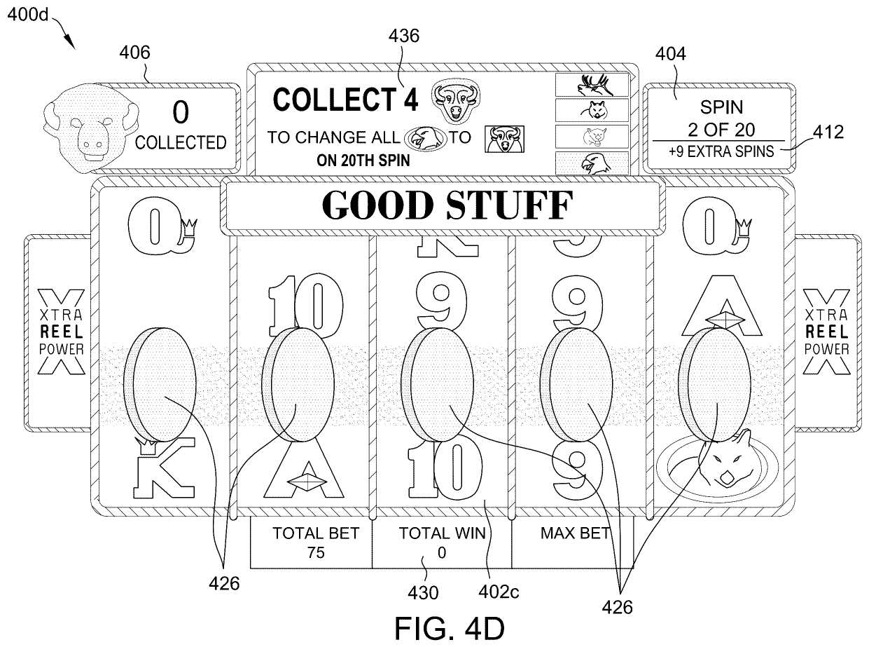

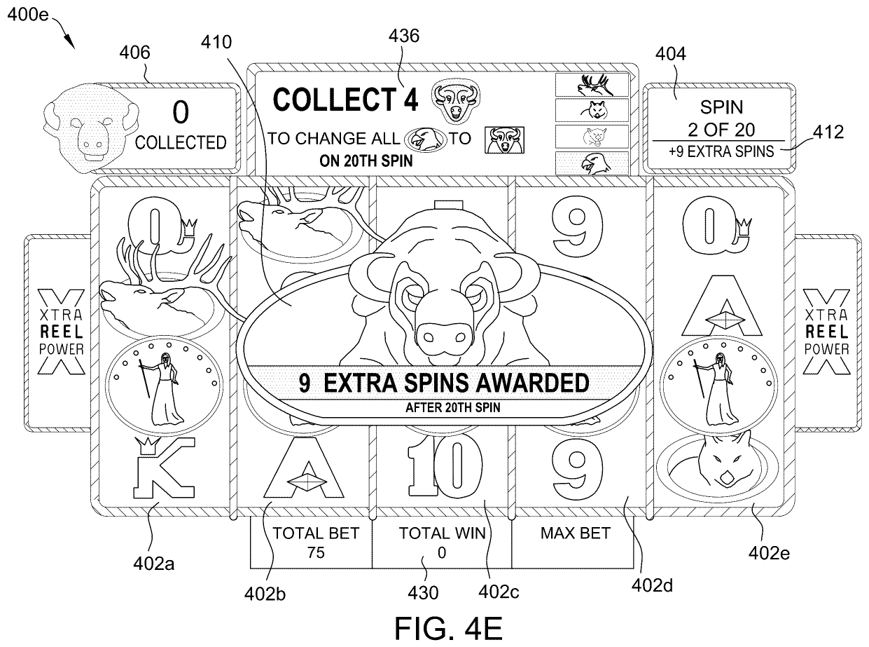

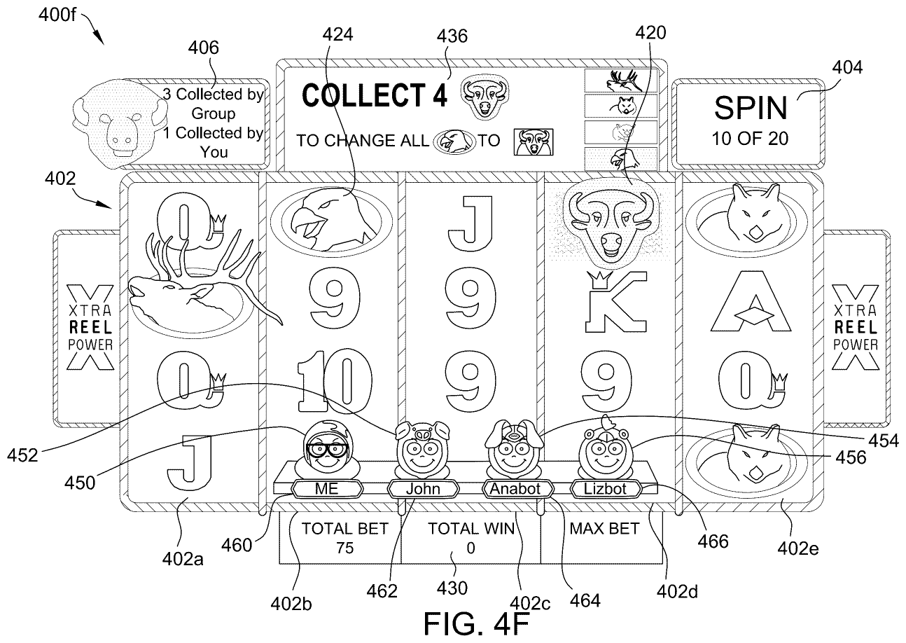

FIGS. 4A-4F are example user interfaces or screenshots 400a-400f of a first example base game played on a gaming device, according to an embodiment, in which one or more elements or designated symbols are counted over a plurality of spins and an award, enhancement, bonus and/or the like is awarded in response to the number of counted elements. In some embodiments, the one or more elements are wild symbols counted over a plurality of spins. In other embodiments, a plurality of wild symbols are counted over a plurality of spins. A plurality of reels 402a-402e are displayed in a primary game display area of a gaming device (e.g., gaming devices 104A-104X shown in FIG. 1, 256 shown in FIG. 2B, and/or 264a-c shown in FIG. 2C) by a game controller (e.g., game controller 202 shown in FIG. 2A). In the example illustrated in FIGS. 4A-4F, the slot game UI comprises a set of five (5) virtual or mechanical reels 402a-402e. However, more or less reels may be displayed. Each of the reels 402a-402e may comprise a plurality of symbols displayed within a symbol position within a matrix 402 which may be associated with winning and/or losing reel game outcomes and/or awards. The game controller 202 (shown in FIG. 2A) may cause to be displayed awarded credit values on a credit meter 430 on the slot game UI.

In operation, game controller 202 may cause a plurality of symbols on reels 402a-402e to be displayed. The plurality of symbols may comprise one or more wild symbols. Upon initiation of a game play instance, the RNG of the gaming device may randomly determine an RNG outcome. The RNG outcome may include reel stops for the plurality of reels 402a-402e displayed on the slot game UI. More particularly, the RNG outcome may include a predetermined number of wild symbols to be displayed in the symbol display positions over a predetermined number of spins (e.g., “n” number of spins).

The predetermined number of spins and the current spin number may be displayed as a numerical indicum on the slot game UI. For example, in FIGS. 4A-4F, the slot game UI comprises a spin counter 404 which indicates the current spin number (i.e., spin ten (10)) and the predetermined number of spins (i.e., twenty (20) spins).

In some embodiments, the game controller 202 may count and record the number of wild symbols displayed over “n−1” number of spins. For example, in FIGS. 4A-4F, the game controller 202 counts and records the number of wild symbols displayed over 19 spins. The number of counted wild symbols may be displayed as a numerical indicum on the slot game UI. In embodiments in which a plurality of wild symbols are being counted, each counted wild symbol may have their own numerical indicum. For example, in FIGS. 4A-4F, the slot game UI comprises wild symbol counter 406. In FIG. 4A, the wild symbol counter 406 displays “0 COLLECTED” since no wild symbols were counted during the first nine (9) spins. In FIG. 4B, the wild symbol counter 406 changes to “1 COLLECTED” since one wild symbol 420 was counted on the tenth (10^{th}) spin. In FIGS. 4A-4F, the wild symbol is a gold buffalo, however various other symbols may be used. The number of counted wild symbols 420 is compared to one or more threshold values.

In some embodiments, if the number of counted wild symbols 420 is greater than or equal to one or more threshold values, a credit amount may be awarded to the player. In some embodiments, an enhancement, such as one or more free bonus spins, may first be awarded to the player, and the credit value may then be awarded to the player on the one or more free bonus spins. Additionally, or alternatively, if the number of recorded wild symbols 420 is greater than or equal to the one or more threshold values, one or more symbols may be converted to the first symbol 422. For example, in the example illustrated in FIGS. 4A-4F, the gold buffalo 420 is transformed into to an ordinary buffalo symbol 422. In some embodiments, the transformation may be accompanied or followed by an animation. For example, after the gold buffalo 420 is transformed into the ordinary buffalo 422, the ordinary buffalo 422 may begin “running”. In some embodiments, the one or more symbols are converted to the first symbol 422 on a last spin of the predetermined number of spins. In the example illustrated in FIGS. 4A-4F, the predetermined number of spins is twenty (20), the wild symbols are counted over nineteen (19) spins and if the number of counted wild numbers are greater than or equal to one or more threshold values, the symbols are converted on the twentieth (20^{th}) spin.

In other embodiments, the game controller 202 may count and record the number of wild symbols displayed over “n” number of spins and the one or more symbols are converted to one or more other symbols once the one or more threshold values is achieved. For example, if the number of counted wild symbols are greater than or equal to one or more threshold values, the wild symbols are converted on the next subsequent spin. In other embodiments, the game controller 202 may count and record the number of wild symbols displayed over “n” number of spins, compare the number of wild symbols to one or more threshold values and convert the one or more symbols to one or more other symbols after the “n” number of spins, the symbols remaining converted for “p” number of spins.

In FIG. 4C, there is a first threshold value of four (4) to convert a second symbol 424 (i.e., eagle symbol) to the first symbol 422 (i.e., buffalo symbol). Converting the second symbol 424 to the first symbol 422 increases the number of first symbols 422 and thereby increase the chances of a player achieving a reel strip win. In some embodiments, symbols that are converted to the first symbol 422 are framed or have some other indication that they are converted symbols. In FIG. 4C, four (4) wild symbols are counted over nineteen (19) spins, and therefore the second symbol 424 is converted to the first symbol 422 on the twentieth (20^{th}) spin. In FIG. 4C, a pop-up 408 appears on the screen to indicate to the player that one or more symbols will be converted to the first symbol. In some embodiments, the pop-up may appear immediately before the last spin of the predetermined number of spins. In the example illustrated in FIG. 4C, pop-up 408 indicating that the eagle symbol is converted to the buffalo symbols appears after the nineteenth spin (19^{th}) out of a total of twenty (20) spins.

The number of counted wild symbols may be compared to additional threshold values. For example, in FIGS. 4A-4C, the game has a first threshold value of four (4) and a second threshold value of seven (7). If the number of counted wild symbols is greater than or equal to a second threshold value, a third symbol may be converted to the first symbol 422 (i.e., the buffalo symbol), in addition to the second symbol 424 being converted to the first symbol 422. The number of counted wild symbols may additionally be compared to a third threshold to convert a fourth symbol to the first symbol, a fourth threshold to convert a fifth symbol to the first symbol, and so on. The symbols may all be converted to the first symbol on the last, or “n^{th}” spin (i.e., the twentieth (20^{th}) spin in FIGS. 4A-4F), as described above with respect to converting the second symbol to the first symbol.

The one or more threshold values may be displayed on the slot game UI. For example. In FIGS. 4A-4F, the number of counted wild symbols needed to convert the second symbol 424 to the first symbol 422 is indicated on a thresholder counter 436. The threshold counter 436 may be updated each time a wild symbol is counted. In some embodiments, the threshold counter 436 counts down from the threshold value each time a wild symbol is counted. For example, in FIG. 4A, when no wild symbols have been counted, the threshold counter 436 is at four (4). In FIG. 4B, after one (1) wild symbol has been counted, the threshold counter 436 decrements to three (3). In some embodiments, after a first threshold value has been achieved the threshold counter 436 may be updated to according to a second threshold value. For example, in FIGS. 4A-4C, the game has a first threshold value of four (4) and a second threshold value of seven (7). Therefore, once the first threshold value of four (4) is achieved, the threshold counter 436 is updated to display a value three (3) additional wild symbols that is needed to convert a third symbol to the first symbol 422. If the second threshold value is achieved, the third symbol may be converted to the wild symbol on the “n^{th}” spin (i.e., the twentieth (20^{th}) spin in FIGS. 4A-4F). In FIGS. 4A-4F, if a total of seven (7) gold buffalo are counted over nineteen (19) spins, then both the eagle symbols and the cougar symbols on reels 402a-402e may be converted to the buffalo symbol 422 and a payout may occur on the twentieth (20^{th}) spin.

FIGS. 4D and 4F are example user interfaces or screenshots 400d and 400e, respectively, of the example base game illustrated in FIGS. 4A-4C, according to an embodiment, in which additional symbols may be counted. In some embodiments, one or more of the reels 402a-402e may comprise a coin symbol 426, which may be counted over the predetermined number of spins, or “n” number of spins. For example, in FIGS. 4A-4F a player may collect coin symbols 426 over twenty (20) spins. The number of counted coined symbols 426 may be compared to one or more threshold values. If the number of counted coin symbols 426 is greater than or equal to the one or more threshold values, one or more enhancements may be awarded to the player. In some embodiments, one or more thresholds being reached may be accompanied by an animation. In the example illustrated in FIG. 4D, the coin symbols 426 become enlarged and rotate.

In some embodiments, the enhancement is one or more free extra spins, or “bonus” spins. The one or more bonus spins increase the chances of a player achieving a reel strip win. In some embodiments, a pop-up 410 may appear on the screen to indicate to the player that one or more bonus spins or other enhancement has been awarded. In the example illustrated in FIG. 4E, nine (9) bonus spins are awarded on the 20^{th} spin and this is communicated to the player via pop-up 410. In some embodiments, the slot game UI may comprise a bonus spin counter 412. A player may further improve their payout on a bonus spin. For example, a player may collect additional wild symbols on a bonus spin to convert another symbol to the first symbol, further increasing the chances of a reel strip win. In some embodiments, the symbols that were converted to the first symbol 422 during the predetermined number of spins, or “n” number of spins, remain as the first symbol 422 during the bonus spins.

There may be a plurality of thresholds and each threshold may correspond to a number of bonus spins. For example, in some embodiments, if a player collects three (3) coin symbols 426 (i.e., the first threshold), the player is awarded three (3) bonus spins, if the player collects four (4) coin symbols (i.e., the second threshold), the player is awarded six (6) bonus spins, and if the player collects five (5) coin symbols (i.e., the third threshold), the player is awarded nine (9) bonus spins. The game controller 202 may cause to be displayed the number of bonus spins awarded on a bonus spin counter on the slot game UI. In the example illustrated in FIG. 4E, the bonus counter 412 displays “+9 EXTRA SPINS” after five (5) gold coins were counted (i.e., the third threshold was reached). The bonus spin counter 412 may be updated when a player is awarded additional bonus spins. In some embodiments, a player may further improve their payout on a bonus spin. For example, a player may collect additional gold coins on a bonus spin, and possibly win additional bonus spins. In some embodiments, the one or more thresholds associated with the gold coins may be lowered. Continuing with the preceding example, the first threshold for bonus spins may be two (2) gold coins, instead of three (3). Therefore, if a player collects two (2) gold coins on one or more bonus spins, the player may be awarded three (3) additional bonus spins.

FIG. 4F is an example user interface or screen shot 400f of an embodiment of a first example game in which multiple players are participating. In the embodiment illustrated in FIG. 4F, the first example game comprises a plurality of player positions, such as a first player position 450, a second player position 452, a third player position 454, and a fourth player position 456. In each player position 450-456, a player (e.g., human player) or a bot player is displayed. Specifically, a first human player 460 (“Me”) is displayed in first player position, 450, a second human player 462 (“John”) is displayed in second player position 452, a first bot player 464 (“AnaBot”) is displayed in third player position 454, and a second bot player 466 (“LizBot”) is displayed in fourth player position 456. Although two human players 460, 462 and two bot players 464, 466 are shown in the example of FIG. 4F, it will be appreciated that any suitable number of human players 460, 462 and bot players 464, 466 may participate, as described herein, in first example game. Stated another way, bots other than and/or including bot players 464, 466 may also participate in first example game.

For convenience, human players 460, 462 and bot players 464, 466 may be collectively referred to herein as “players” 460-466. In addition, as described above, bot players 464, 466 may in some instances simply be referred to as “bots.”

In some embodiments, each of the players 460-466 play the first example game, and game controller 202 counts one or more wild symbols landed on each spin by each individual player of the group of players 460-466. Stated another way, players 460-466 may work together to collect one or more wild symbols. The counted one or more wild symbols may be compared to one or more thresholds, and one or more symbols may be converted to other symbols, an enhancement may be awarded, etc., based on the number of counted one or more wild symbols, as described above. In the example illustrated in FIG. 4F, numerical indicum 406 displays the number of wild symbols collected by the group of players 460-466, as well as the wild symbols collected by the player 460. In some embodiments, bots 464, 466 are selected for use during the game from a bot selection table, as disclosed in U.S. patent application Ser. No. 16/584,227, now U.S. Pat. No. 10,970,957, entitled “SYSTEMS AND METHODS FOR SIMULATING PLAYER BEHAVIOR USING ONE OR MORE BOTS DURING A WAGERING GAME”, filed Sep. 26, 2019, the disclosure of which is hereby incorporated by reference in its entirety.

Although FIGS. 4A-4F are described as being a part of a base or primary game, the above-described embodiments could also be incorporated into play of a bonus game. For example, in some embodiments, game controller 202 may count and record the number of wild symbols displayed over “n−1” number of spins of a bonus game or bonus spins. The number of counted wild symbols over “n−1” number of spins of a bonus game or bonus spins is compared to one or more threshold values. If the number of recorded wild symbols is greater than or equal to the one or more threshold values, one or more symbols may be converted to one or more other symbols. In other embodiments, game controller 202 may count and record the number of wild symbols displayed over “n” number of spins of a bonus game or bonus spins. The number of counted wild symbols is compared to one or more threshold values after each spin. If the number of recorded wild symbols is greater than or equal to the one or more threshold values, one or more symbols may be converted to one or more other symbols on the subsequent spin. In some embodiments, the one or more symbols may remain converted for the duration of the bonus game or for the remainder of the bonus spins.

In other embodiments, the game controller 202 may count and record the number of wild symbols displayed over “n” number of spins, compare the number of wild symbols to one or more threshold vales and convert the one or more symbols to one or more other symbols after the “n” number of spins, the symbols remaining converted for “p” number of spins.

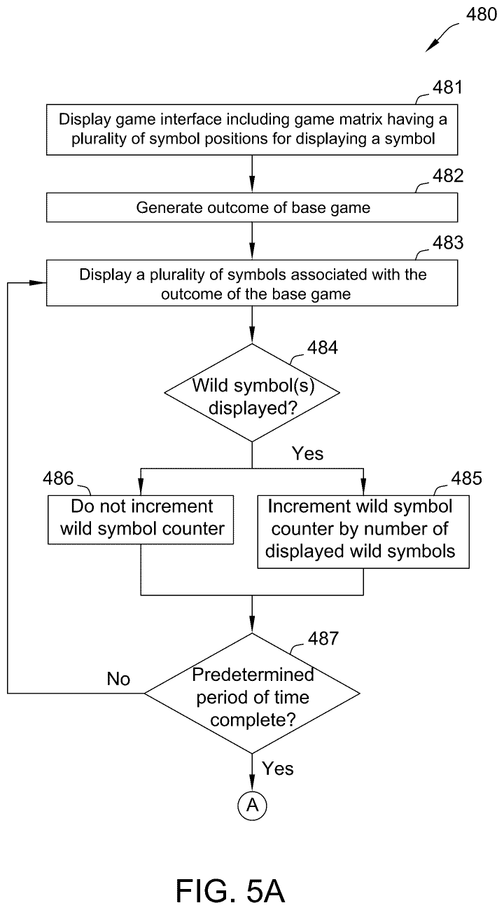

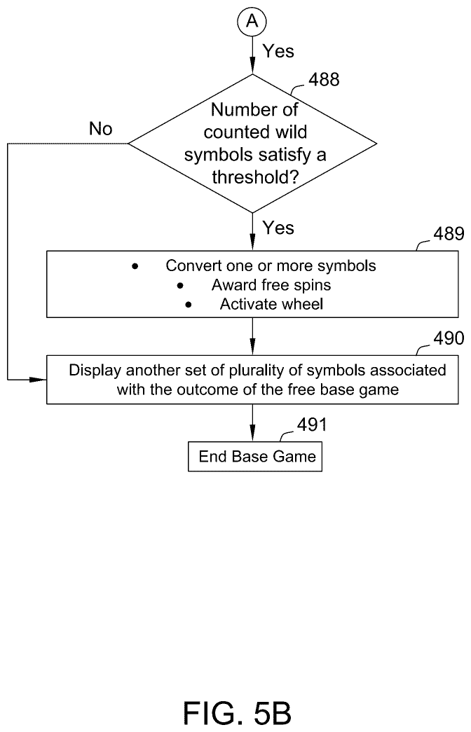

FIGS. 5A and 5B illustrate flow diagram 480 of an example embodiment of a process for implementing a gaming instance in which wild symbols are counted over a number of spins, as described with reference to FIGS. 4A-4F. The example embodiment may be stored as instructions on at least one memory device of a gaming system. At 481, a game interface including a game matrix may be displayed. The game matrix may comprise a plurality of symbol positions for displaying a symbol. At 482, an outcome of the base game may be generated. At 483, the processor may cause to be displayed a first plurality of symbols within the symbol positions. The first plurality of symbols may be associated with the outcome of the base game. At 484 it is determined if the first plurality of symbols within the symbol positions include one or more wild symbols. If the first plurality of symbols includes one or more wild symbols, a wild symbol counter is incremented by the number of displayed wild symbols at 485. If no wild symbols are displayed, the method proceeds to 486 and the wild symbol counter is not incremented. At 487, if a predetermined period of time is complete, then the processor determines whether the number of counted wild symbols satisfies a threshold at 488. The predetermined period of time may comprise whether a time period has elapsed, whether the gaming instance has performed a predetermined number of spins, etc. For example, in the embodiment illustrated in FIGS. 4A-4F, the predetermined period of time at 488 is “n−1” number of spins, or nineteen (19) spins. If the predetermined period of time is not met, the method may skip to 490 and another set of plurality of symbols associated with the base game outcome is displayed. If the number of counted wild symbols satisfies a threshold, one or more other symbols may be converted to another symbol, a number of free spins may be awarded, and/or a bonus wheel game may be activated at 489. The method may then go to 490, at which another set of a plurality of symbols associated with the outcome of the base game is be displayed and then the base game may end at 491. If one or more bonus games were awarded during the base game, the gaming instance may then enter into a bonus game.

### Exemplary Gaming Instance—Counting Wild Symbols to Extend Number of Spins

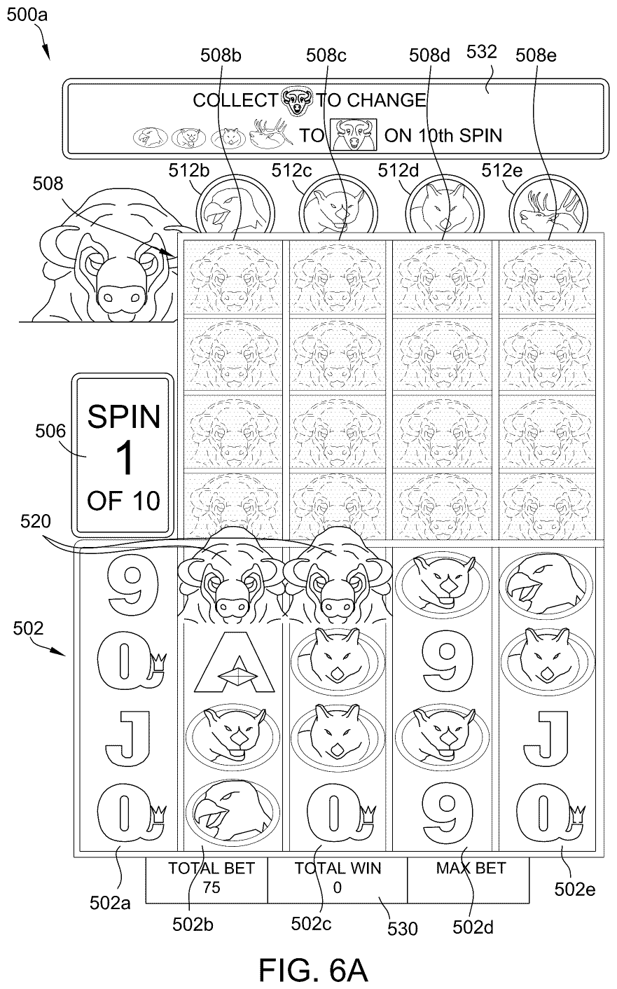

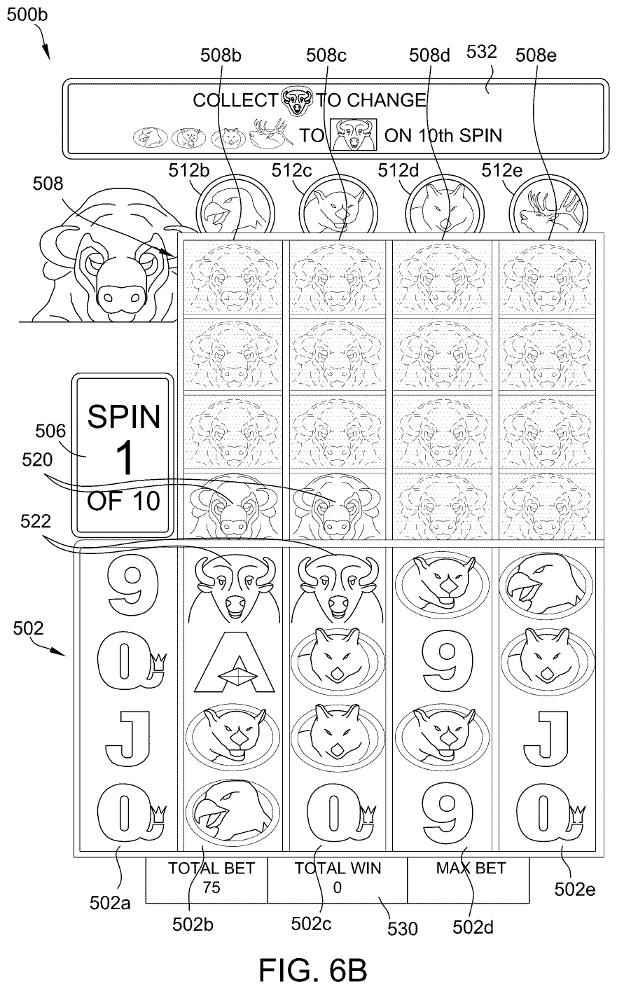

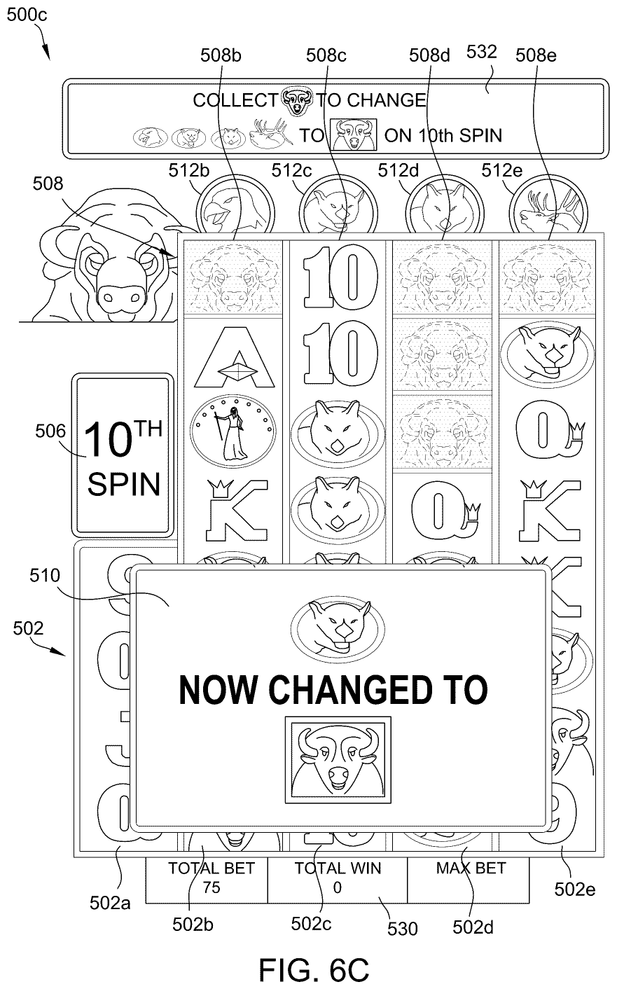

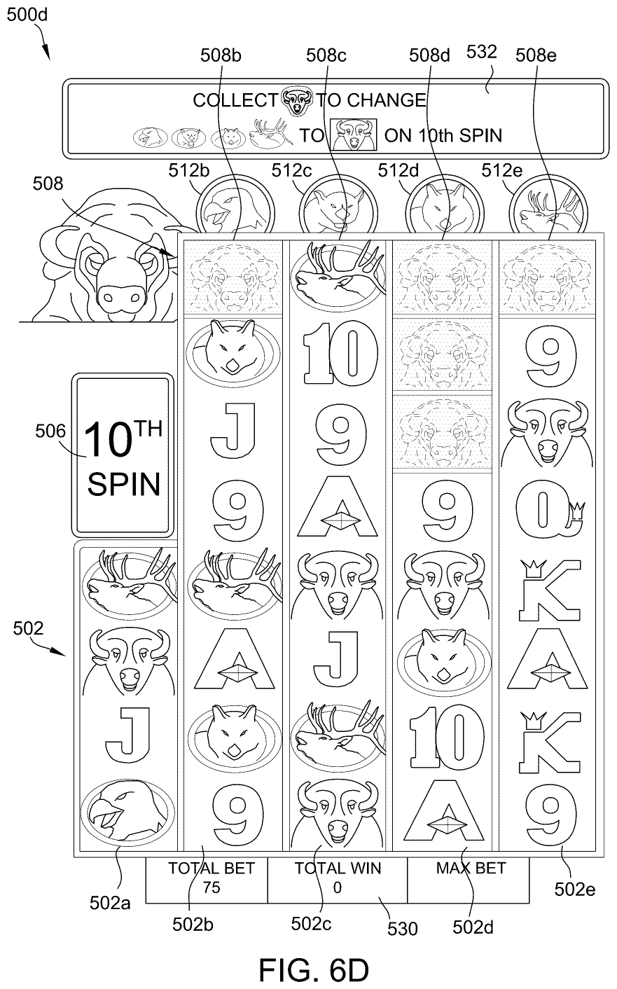

FIGS. 6A-6D are example user interfaces or screenshots 500a-500d of a second example base game played on a gaming device, according to an embodiment, in which one or more wild symbols are counted over a plurality of spins. In some embodiments, one wild symbol is counted over a plurality of spins. In other embodiments, a plurality of wild symbols are counted over a plurality of spins. In the example of FIGS. 6A-6D, a plurality of reels 502a-502e are displayed in a primary game display area of a gaming device (e.g., gaming devices 104A-104X shown in FIG. 1, 256 shown in FIG. 2B, and/or 264a-c shown in FIG. 2C) by a game controller (e.g., game controller 202 shown in FIG. 2A). In the example of FIGS. 6A-6D, the slot game UI comprises a set of five (5) virtual or mechanical reels 502a-502e. However, more or less reels may be displayed. Each of the reels 502a-502e may comprise a plurality of symbols displayed within a symbol position within the matrix 502 which may be associated with winning and/or losing reel game outcomes and/or awards. The slot game UI may further comprise a bonus matrix 508 comprising a plurality of symbol positions which may display symbols. The bonus matrix 508 may comprise bonus reels 508b-508e. The bonus reels may be located above and be aligned with reels 502b-502e. In the example illustrated in FIGS. 6A-6D, there are four (4) bonus reels. However, there may be more or less bonus reels. Further, in the example illustrated in FIGS. 6A-6D, each of the bonus reels 508b-508e has an equal number of rows (e.g., four (4) rows). However, the bonus reels 508b-508e may have different numbers of rows. For example, reel 508b may have “x” number of rows (e.g., 3 rows) and reel 508c may have “y” number of rows (e.g., 4 rows). In some embodiments, the number of rows in a bonus reel is determined using an RNG and the UI (e.g., number of rows in each reel) is configured based upon the outcome or output of the RNG. The bonus reels 508b-508e may include deactivated symbol positions. Upon one or more conditions, the deactivated symbol positions may become active during a gaming instance. The game controller 202 may cause awarded credit values to be displayed on a credit meter 530 on the slot game UI. The game controller 202 may cause to be displayed an informational display 532 which indicates that gold buffalo may be counted to convert a symbol to the wild symbol on the last spin of a predetermined number of spins.

Upon initiation of a game play instance, the RNG of the gaming device may randomly determine an RNG outcome. The RNG outcome may include reel stops for the plurality of reels 502a-502e displayed on the slot game UI. More particularly, the RNG outcome may consist of a predetermined number of wild symbols to be displayed in the symbol display positions over a plurality of spins. The number of spins may be displayed as a numerical indicum on the slot game UI. For example, in the example illustrated in FIGS. 6A-6D, the slot game UI comprises spin counter 506. In FIG. 6A, spin counter 506 displays “SPIN 1 of 10”, indicating that the base game is on the first (1^{st}) spin of a total of ten (10) spins. The predetermined number of wild symbols may be displayed within symbol positions within the matrix 502 over a plurality of spins. In the example illustrated in FIGS. 6A-6D, the wild symbol is a gold buffalo. When a wild symbol is displayed within a symbol position on the matrix 502, the wild symbol may be transported to a corresponding symbol position on one of the bonus reels 508b-508e. For example, in FIGS. 6A-6C, the wild symbol displayed in reel 502b is transported to bonus reel 508b. After the wild symbol is transported to a bonus reel 508b-508e, a first symbol 522 may replace the wild symbol within the symbol position in which the wild symbol appeared. For example, in FIG. 6B ordinary buffalo symbols 522 are displayed in the symbol positions in which the wild symbols 520 appeared in FIG. 6A.

In some embodiments, when all of the symbol positions of at least one bonus reel are filled with wild symbols 520, a credit amount may be awarded to the player. In some embodiments, an enhancement, such as one or more free bonus spins, may first be awarded to player, and the credit value may be awarded to the player on the one or more free bonus spins. Additionally, or alternatively, when all of the symbol positions of at least one bonus reel are filled with wild symbols 520, one symbol may be converted to another symbol. In some embodiments, each of the bonus reels 508b, 508c, 508d and 508e may correspond to a second symbol 512b, a third symbol 512c, a fourth symbol 512d, and a fifth symbol 512e, respectively. The corresponding symbol may be displayed above each of the bonus reels 508a-508e. If all of the symbol positions of a bonus reel 508b-508e are filled with a wild symbol, the symbol which corresponds to that bonus reel may be converted to the first symbol 522. For example, if all of the symbol positions within bonus reel 508b are filled with wild symbols, then the second symbol 512b (i.e., the eagle symbol) may be converted to the first symbol 522 (i.e., the buffalo symbol).

A pop-up may appear on the screen to indicate to the player that one or more symbols are converted to the first symbol 422. In some embodiments, the pop-up may appear immediately before the last spin of the predetermined number of spins. For example, in FIG. 6C, a pop-up 510 indicating that bonus reel 508c has been filled with wild symbols, and therefore each of the third symbols 512c (i.e., the cougar symbol) will be converted to the first symbol 522 (i.e., the buffalo symbol) and will appear after the ninth (9^{th}) spin. The third symbol 512c (i.e., the cougar symbol) is then converted to the first symbol 522 (i.e., the buffalo symbol) within the active symbol positions of the reels 502a-502e and 508b-508e on the tenth (10^{th}) spin. in some embodiments, the symbols which were converted are framed or have some other indication that they are converted symbols.

In some embodiments, when all of the symbol positions of at least one bonus reel are filled with wild symbols 520, all symbol positions that include the wild symbol 520 become active on the last spin of the predetermined number of spins. In the example illustrated in FIGS. 6C-6D, all symbol positions on bonus reels 508b-508e that include a gold buffalo become active on the tenth (10^{th}) spin.

In some embodiments, the game controller 202 may cause to be displayed one or more coin symbols (e.g., coin symbol 426 shown in FIG. 4D) within active symbol positions within reels 502a-502e and 508b-508e on a spin. The number of coin symbols displayed on a spin within reels 502a-502e and 508b-508e of FIGS. 6A-6D may be compared to one or more threshold values. If the number of coin symbols is greater than or equal to the one or more threshold values, one or more enhancements may be awarded to the player. In some embodiments, one or more thresholds being reached may be accompanied by an animation. For example, the coin symbols 426 may become enlarged and rotate, as shown in FIG. 4D. In some embodiments, the enhancement is one or more free bonus spins. In some embodiments, a player may further improve their payout on a bonus spin. For example, a player may collect additional wild symbols on a bonus spin to convert another symbol to the first symbol, increasing the chances of a reel strip win. In some embodiments, the symbols that were converted to the first symbol remain as the first symbol on a bonus spin.

In some embodiments, there may be a plurality of thresholds and each threshold may correspond to a number of bonus spins. For example, the game controller 202 may cause to be displayed: three (3) gold coins (i.e., the first threshold), in which three (3) bonus spins are awarded; four (4) gold coins (i.e., the second threshold), in which six (6) bonus spins are awarded; or five (5) gold coins (i.e., the third threshold), in which nine (9) bonus spins are awarded. The game controller 202 may cause to be displayed the number of bonus spins awarded on a bonus spin counter (not shown) on the slot game UI. The bonus spin counter may be updated when a player is awarded additional bonus spins. In some embodiments, a player may further improve their payout on a bonus spin. For example, a player may collect additional gold coins on a bonus spin, and possibly win additional bonus spins. In some embodiments, the one or more thresholds associated with the gold coins may be lowered. Continuing with the preceding example, the first threshold for bonus spins may be two (2) gold coins, instead of three (3). Therefore, if a player collects two (2) gold coins on one or more bonus spins, the player may be awarded three (3) additional bonus spins.

In some embodiments, gaming device 104A may also include a topper wheel 134 (shown in FIG. 1), as discussed above. The topper wheel may comprise one or more indicators 136 indicating the outcome of the game. In some embodiments, the topper wheel comprises a plurality of indicators 136. In further embodiments, each indicator is associated with a reel 502a-502e and/or bonus reel 508b-508d. In some embodiments, when all of the symbol positions of a reel of the bonus matrix 508 are filled with coin symbols, the game controller 202 may cause the topper wheel to become activated. In some embodiments, the one or more indicators 136 which correspond to the one or more reels in which all of the symbol positions are filled with coined symbols are activated. The topper wheel 134 may spin and stop and the one or more active indicators may indicate the outcome of the game.

In some embodiments, multiple players may participate in the second example game shown in FIGS. 6A-6D. The players may comprise one or more human players and optionally, one or more bot players, as described above. Each of the players may play the second example game, and game controller 202 counts one or more wild symbols landed on each spin by each individual player of the group of players. Stated another way, players may work together to collect one or more wild symbols. For example, the players may work together to collect one or more wild symbols on a group bonus matrix 508 (e.g., each member of group would view and collect symbols on the same bonus matrix). One or more symbols may be converted to other symbols, an enhancement may be awarded, etc., upon a condition (e.g., a column of bonus matrix being filled with wild symbols), the number of counted one or more wild symbols being greater than or equal to one or more threshold, and the like, as described above.

### Exemplary Gaming Instance—Counting Wild Symbols to Extend Number of Spins

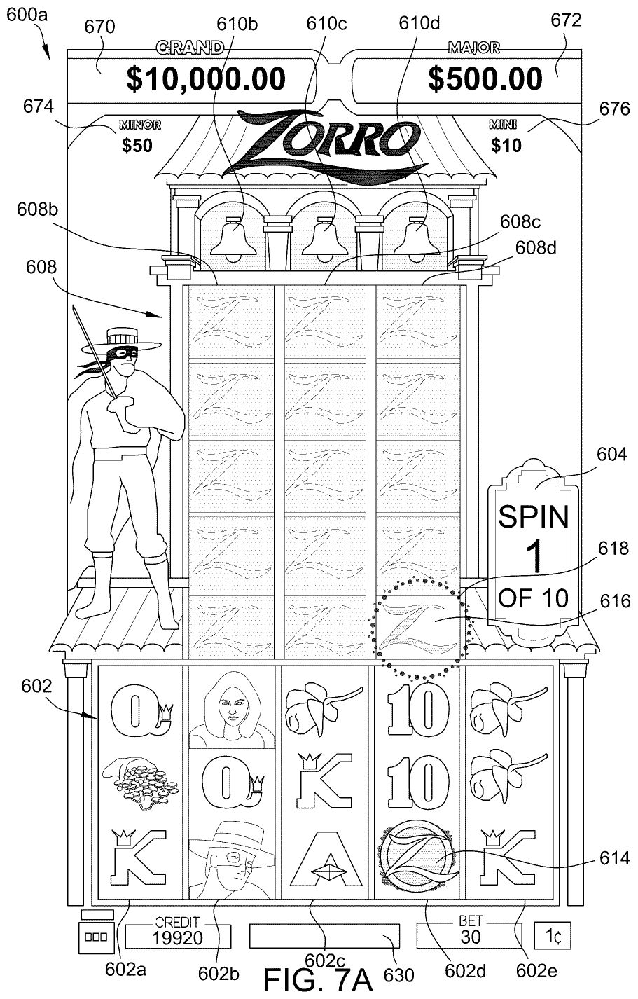

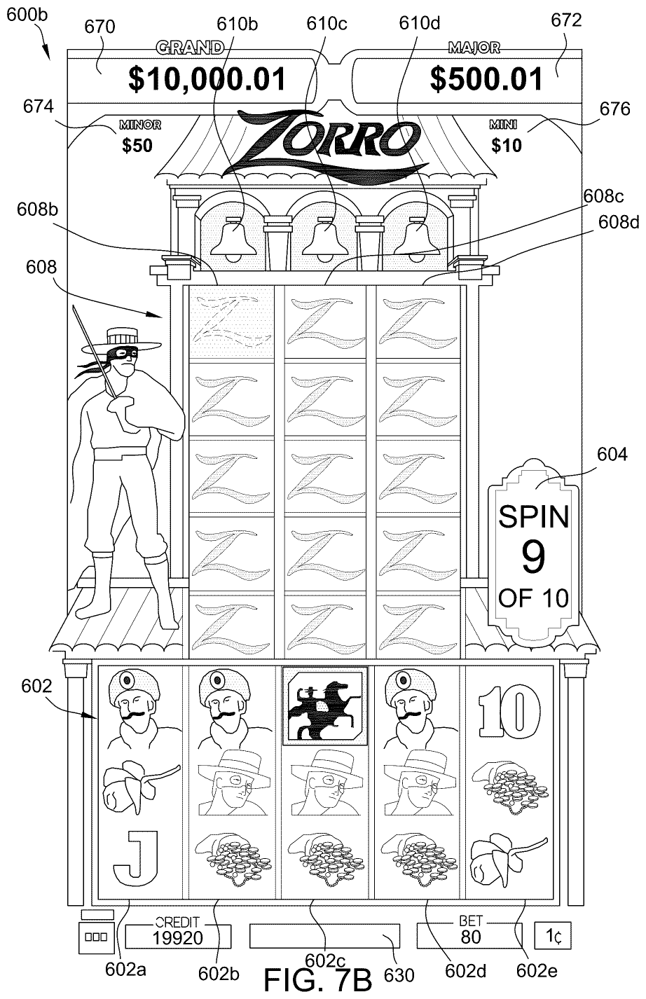

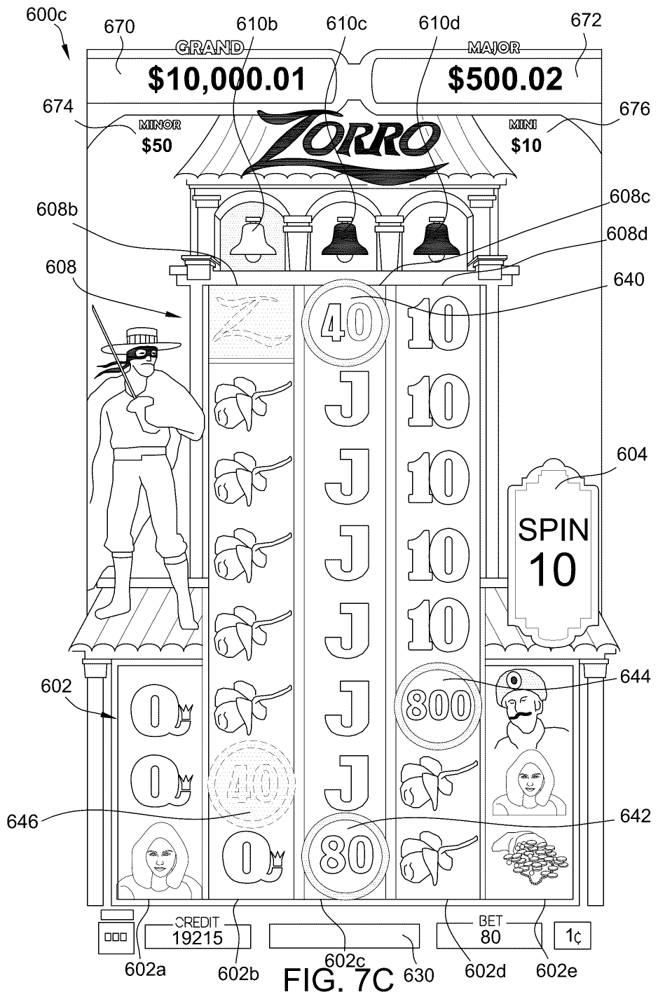

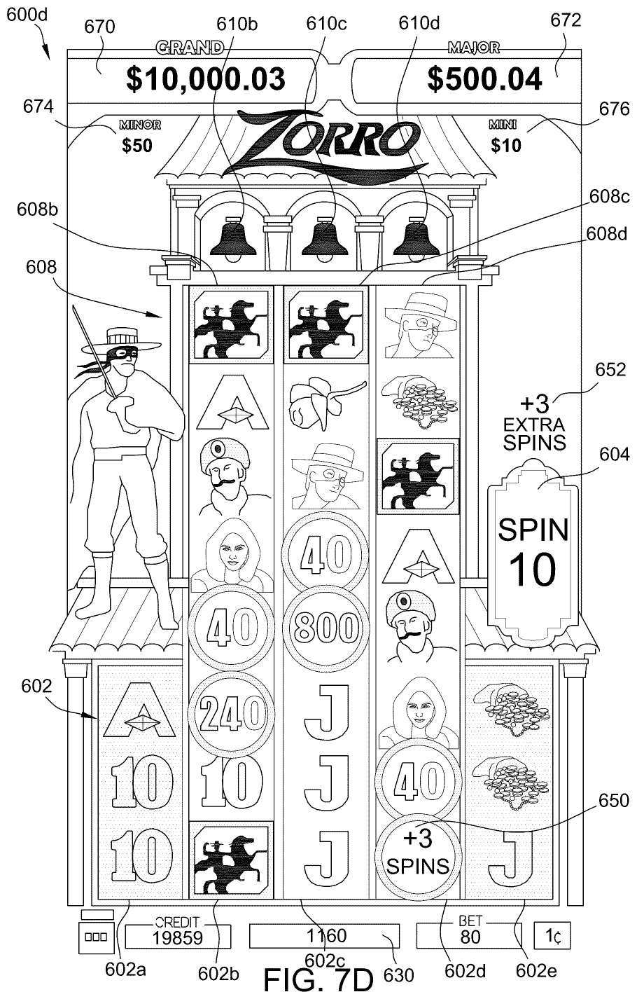

FIGS. 7A-7D are example user interfaces or screenshots 600a-600d of a third example base game played on a gaming device, according to an embodiment, in which one or more wild symbols are counted over a plurality of spins. In the example of FIGS. 7A-7D, a plurality of reels 602a-602e are displayed in a primary game display area of a gaming device (e.g., gaming devices 104A-104X shown in FIG. 1, 256 shown in FIG. 2B, and/or 264a-c shown in FIG. 2C) by a game controller (e.g., game controller 202 shown in FIG. 2A). In the example of FIGS. 7A-7D, the slot game UI comprises a set of five (5) virtual or mechanical reels 602a-602e. However, more or less reels may be displayed. Each of the reels 602a-602e may comprise a plurality of symbols displayed within a symbol position within the matrix 602 which may be associated with winning and/or losing reel game outcomes and/or awards. Game controller 202 may cause to be displayed awarded credit values on a credit meter 630 on the slot game UI.

Upon initiation of a game play instance, the RNG of the gaming device may randomly determine an RNG outcome. The RNG outcome may consist of reel stops for the plurality of reels 602a-602e displayed on the slot game UI. More particularly, the RNG outcome may consist of a predetermined number of wild symbols 614 to be displayed in the symbol display positions over a plurality of spins. The number of spins may be displayed as a numerical indicum on the slot game UI. For example, in the example illustrated in FIG. 7A, spin counter 604 displays “SPIN 1 of 10” indicating the base game is on the first (1^{st}) spin out of a total ten (10) spins. The predetermined number of wild symbols 616 may be displayed within symbol positions on the matrix 602 over a plurality of spins. In the example illustrated in FIGS. 7A-7D, the wild symbol 614 is a “Z” enclosed in a circle. When a wild symbol 614 is displayed within a symbol position within the matrix 602, the wild symbol 614 may be “transported” onto a bonus matrix 608 comprising a plurality of deactivated symbol positions. In some embodiments, the bonus matrix 608 may comprise a plurality of reels 608b-608d. In the example illustrated in FIGS. 7A-7D, the bonus matrix comprises three (3) reels. However, bonus matrix 608 may consist of more or less reels. In some embodiments, each of the reels of the bonus matrix 608 may align with a reel of the matrix. In the example illustrated in FIGS. 7A-7B, reels 602b, 602c, and 602d of matrix 602 align with reels 608b, 608c, and 608d of bonus matrix 608, respectively. Further, in the example illustrated in FIGS. 7A-7B, each of the bonus reels 608b-608d has an equal number of rows (e.g., five (5) rows). However, the bonus reels 608b-608d may have different numbers of rows. For example, reel 608b may have “x” number of rows (e.g., 4 rows) and reel 508c may have “y” number of rows (e.g., 5 rows). In some embodiments, the number of rows in a bonus reel is determined using an RNG. In some embodiments, the position of the wild symbol 614 as it appears on the matrix 602 may correspond to the position it appears on the bonus matrix 608. For example, in FIG. 7A, wild symbol 614 displayed on reel 602d is transported to reel 608d of the bonus matrix 608. In some embodiments, when a wild symbol 614 appears on the matrix 602 it is transported to the next available position on bonus matrix 608. For example, in FIG. 7A, wild symbol 614 displayed on reel 602d is transported to the lowest available position on reel 608d, with a subsequent wild symbol 614 appearing on reel 602d (not shown) transported to the next available position on reel 608d (i.e., stacked upon the previous symbol transported to reel 608d), and so on. In some embodiments, the wild symbol may have a different appearance on the bonus matrix 608 than on the matrix 602. In the example illustrated in FIGS. 7A-7B, the wild symbol is a “Z” enclosed in a circle 614 within the symbol positions on the matrix 602 and a “Z” enclosed in a square 616 within the symbol positions on the bonus matrix 608. In some embodiments, when a wild symbol is revealed, it may be accompanied or followed by an animation, such as a halo 618, fireworks, or the like.

In some embodiments, when all of the symbol positions of at least one bonus reel is filled with wild symbols 614, a credit amount may be awarded to the player. In some embodiments, an enhancement, such as one or more free bonus spins, may first be awarded to player, and the credit value may be awarded to the player on the one or more free bonus spins. Additionally, or alternatively, when all of the symbol positions of at least one reel of the bonus matrix 608 are filled with wild symbols, all symbol positions with a wild symbol become active and will be spun on the last spin of a predetermined number of spins. In the example illustrated in FIGS. 7B-7D, all symbol positions within reels 608c and 608d become active and all but one symbol position in reel 608b becomes active on the tenth (10^{th}) spin. In some embodiments, when all of the symbol positions in a reel of the bonus matrix 608 are filled, there may be an accompanying animation. In the example illustrated in FIG. 7B, reels 608c and 608d are filled with wild symbols and their corresponding bells 610c, 610d light up and starting “ringing”. The bell 610b corresponding to reel 608b, which was not completely filled, remains still and does not light up.

Under certain conditions, cash on reel (COR) symbols and/or multipliers may become activated and awarded to the player. For example, in some embodiments, when all of the symbol positions of a reel of the bonus matrix 608 are filled with wild symbols, COR symbols 640, 642, 644 on that reel may become activated. In the example illustrated in FIG. 7C, reels 608c and 608d were filled with wild symbols, and therefore all of the symbol positions became active on spin ten (10) and COR symbols 640, 642, and 644 on the reels 608c and 608d were activated and the credits associated with the COR symbols awarded on spin ten (10) when they were revealed. Since reel 608b on bonus matrix 608 was not entirely filled with coined symbols, the COR symbols, such as COR symbol 646, were not activated and therefore not awarded on spin ten (10). In some embodiments, a COR award may be accompanied by an animation. The corresponding animation may be a firework, halo, or the like. Additionally, or alternatively, when all of the symbol positions of a reel of the bonus matrix 608 are filled with wild symbols, a multiplier value (e.g., 2×, 3×, etc.) may be awarded. The multiplier may be accompanied by an animation, such as one or more of the bells 610b, 610c, 610d ringing. In some embodiments, a boost multiplier may be awarded. For example, if both a multiplier and a wild symbol are awarded on a spin, a boost multiplier may be awarded.

In some embodiments, when all of the symbol positions of a reel of the bonus matrix 608 are filled with wild symbols, the game controller 202 may cause one or more free spin symbols on that reel may become activated. In some embodiments, the location of the one or more free spin symbols are fixed on a reel. In some embodiments, the free spin symbols may award a player a number of free spins based on a random determination. The random determination may be a ball call or an RNG output and a lookup table. If there is a successful outcome on the random determination, the game controller 202 may cause to be displayed one or more free spin symbols within the active symbol positions. In some embodiments, the free spin symbol may first appear as a mystery symbol, which is then revealed to be the free spin symbol and may indicate the number of free spins awarded. In the example illustrated in FIG. 7D, a diamond is displayed which is then revealed to be “+3 SPINS” symbol 650. In some embodiments, the symbol positions of the bonus matrix 608 that were activated may remain activated during the awarded bonus spins. In some embodiments, game controller 202 may cause additional bonus spins to be awarded during a bonus spin. The game controller 202 may cause the slot machine game UI to display the number of bonus spins awarded on a bonus spin counter 652.

In some embodiments, when all of the symbol positions of a reel of the bonus matrix 608 are filled with wild symbols, the game controller 202 may cause one or more jackpot symbols on that reel to become activated. In some embodiments, the location of the jackpot symbols are fixed on a reel. In some embodiments, the free spin symbols may award a player a number of free spins based on a random determination. The random determination may be a ball call or an RNG output and a lookup table. If there is a successful outcome on the random determination, the game controller 202 may cause to be displayed the jackpot symbols within active symbol positions on the slot game UI. The jackpot symbols may identify a jackpot (grand, major, minor, mini, etc.).

Game controller 202 may also cause to be displayed a plurality of bonus jackpot meters 670, 672, 674, 676 on the slot game UI, including a grand jackpot meter 670, a major jackpot meter 672, a minor jackpot meter 674, and a mini jackpot meter 676. The game controller 202 may cause to be displayed credit values on jackpot meters 670, 672, 674, 676 to be awarded if a jackpot is won.

In some embodiments, gaming device 104A may also include a topper wheel 134 (shown in FIG. 1), as discussed above. The topper wheel may comprise one or more indicators 136 indicating the outcome of the game. In some embodiments, the topper wheel comprises a plurality of indicators 136. In further embodiments, each indicator is associated with a reel 602a-602e and/or bonus reel 608b-608d. In some embodiments, when all of the symbol positions of a reel of the bonus matrix 608 are filled with wild symbols, the game controller 202 may cause the topper wheel to become activated. In some embodiments, the one or more indicators 126 which correspond to the one or more reels in which all of the symbol positions are filled with wild symbols are activated. The topper wheel 134 may spin and stop and the one or more active indicators may indicate the outcome of the game. In some embodiments, the topper wheel may become activated on the 10^{th} spin, with the one or more indicators 126 which correspond to the one or more reels in which all of the symbol positions are filled with wild symbols may become activated, and the one or more indicators 126 may indicate (with the spin and stop of the wheel) the outcome of the game.

In some embodiments, multiple players may participate in the third example game. The players may comprise one or more human players and optionally, one or more bot players, as described above. Each of the players may play the third example game, and game controller 202 counts one or more wild symbols landed on each spin by each individual player of the group of players. Stated another way, players may work together to collect one or more wild symbols. For example, the players may work together to collect one or more wild symbols on a group bonus matrix 608 (e.g., each member of group would view and collect symbols on the same bonus matrix). One or more symbols may be converted to other symbols, an enhancement may be awarded, etc., upon a condition (e.g., a column of bonus matrix being filled with wild symbols), the number of counted one or more wild symbols being greater than or equal to one or more threshold, and the like, as described above.

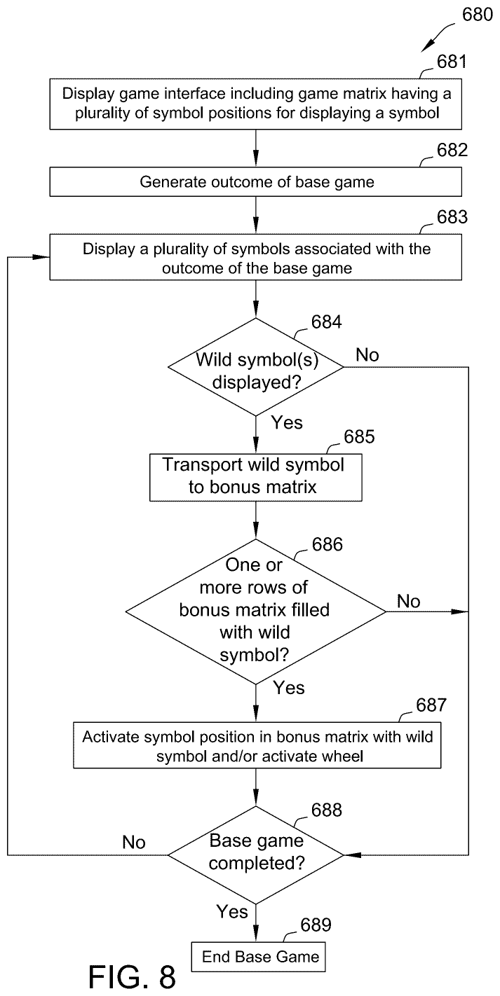

FIG. 8 is a flowchart 680 illustrating an example embodiment of a process for implementing a wagering game in which wild symbols are counted and symbol positions within a bonus matrix become active, as described with reference to FIGS. 6A-6D and FIGS. 7A-7D. The example embodiment may be stored as instructions on at least one memory device of a gaming system. At 681, a game interface including a game matrix may be displayed. At 682, an outcome of the base game may be generated. At 683, the processor may cause to be displayed a plurality of symbols associated with the outcome of the base game. At 684 it is determined if one or more wild symbols are displayed. If one or more wild symbols are displayed, the wild symbols are transported to a bonus matrix at 685. At 686 it is determined whether one or more rows of the bonus matrix are filled with the wild symbol. If one or more rows are filled, symbol positions in the bonus matrix with a wild symbol are activated at 687. Additionally, or alternatively, a bonus wheel game may be activated. At 688 it is determined whether the base game has ended (e.g., predetermined number of spins has been completed, a time period has elapsed, etc.). If it is determined that the base game has not completed, the gaming instance may return to 683 and display another set of a plurality of symbols associated with the outcome of the base game. If it is determined that the base game is completed, the base game may end at 689. If one or more bonus games were awarded during the base game, the gaming instance may then enter into a bonus game.

### Exemplary Gaming Instance—Tracking Letter Symbols to Receive Bonus Feature

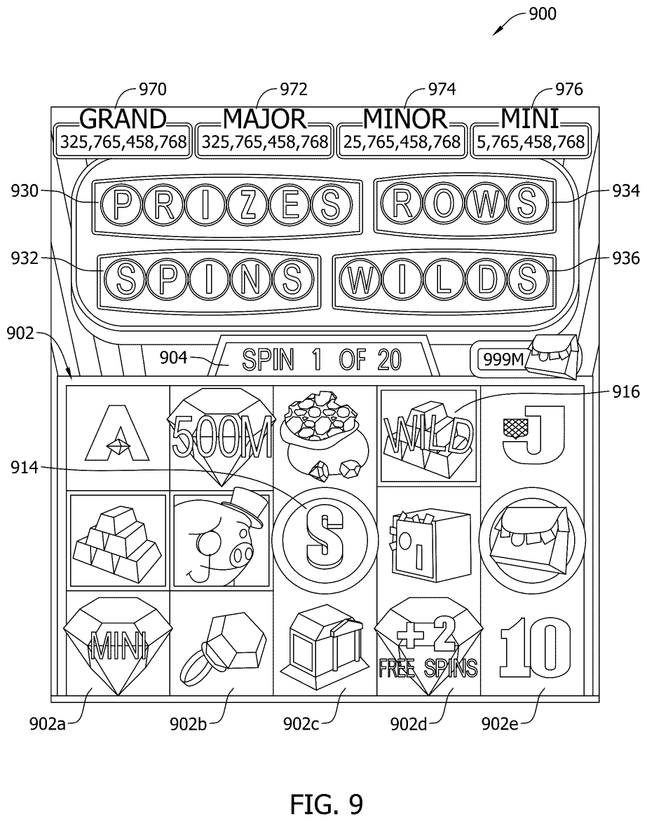

FIG. 9 is an example user interface or screenshot 900 of a fourth example base game played on a gaming device, according to an embodiment, in which one or more letters symbols are tracked over a plurality of spins. In the example of FIG. 9, a plurality of reels 902a-902e are displayed in a primary game display area of a gaming device (e.g., gaming devices 104A-104X shown in FIG. 1, 256 shown in FIG. 2B, and/or 264a-c shown in FIG. 2C) by a game controller (e.g., game controller 202 shown in FIG. 2A). In the example of FIG. 9, the slot game UI comprises a set of five (5) virtual or mechanical reels 902a-902e. However, more or less reels may be displayed. Each of the reels 902a-902e may comprise a plurality of symbols displayed within a symbol position within the matrix 902 which may be associated with winning and/or losing reel game outcomes and/or awards. Game controller 202 may cause to be displayed awarded credit values on a credit meter 630 on the slot game UI. Game controller 202 may also cause to be displayed a plurality of bonus jackpot meters 970, 972, 974, 976 on the slot game UI, including a grand jackpot meter 970, a major jackpot meter 972, a minor jackpot meter 974, and a mini jackpot meter 976. The game controller 202 may cause to be displayed credit values on jackpot meters 970, 972, 974, 976 to be awarded if a jackpot is won.

Upon initiation of a game play instance, the RNG of the gaming device may randomly determine an RNG outcome. The RNG outcome may consist of reel stops for the plurality of reels 902a-902e displayed on the slot game UI. More particularly, the RNG outcome may include letter symbols 914 to be displayed in the symbol display positions over a plurality of spins. Letter symbols 914 displayed over a plurality of spins may spell out a word, such as “P-R-I-Z-E-S” 930, “S-P-I-N-S” 932, “R-O-W-S” 934, or “W-I-L-D-S” 936. Upon spelling out a word, a credit value may be awarded to the player. Additionally, or alternatively, an enhancement, a bonus game, or the like, may be awarded to the player, as described in more detail below. In some embodiments, an enhancement, such as one or more free bonus spins, may first be awarded to the player, and the credit value may be awarded to the player on the one or more free bonus spins. The number of spins may be displayed as a numerical indicum on the slot game UI. For example, in the example illustrated in FIG. 9, spin counter 904 displays “SPIN 1 of 20” indicating the base game is on the first (1^{st}) spin out of a total twenty (20) spins. Letter symbols 914 may be displayed within symbol positions on the matrix 902 over a plurality of spins. In some embodiments, letter symbols 914 are displayed over “n−1” number of spins and one or more awards and/or enhancements are provided on the “n^{th}”, spin. In other embodiments, letter symbols 914 are displayed over “n−1” number of spins and one or more awards and/or enhancements are provided over “p” number of spins which may be part of the base game or a bonus game.

In the embodiment illustrated in FIG. 9, the letter symbols 914 landed on over nineteen (19) spins are tracked, and if the letter symbols landed on spell “P-R-I-Z-E-S” 930, “S-P-I-N-S” 932, “R-O-W-S” 934, or “W-I-L-D-S” 936, the player may receive a bonus feature. For example, in some embodiments, if the letter symbols landed on over nineteen (19) spins spell out “P-R-I-Z-E-S,” on the twentieth (20^{th}) spin, at least one cash on reel (COR) symbol may be added to a symbol position within matrix 902, and the player is awarded any COR value displayed on the final twentieth (20^{th}) spin. In some embodiments, if the letter symbols landed on over nineteen (19) spins spell out “W-I-L-D-S,” on the twentieth (20^{th}) spin, the player will be awarded a “Free Games Bonus” with a random number of wild symbols 916 added to symbol positions within matrix 902. In some embodiments, if the letter symbols landed on over nineteen (19) spins spell out “S-P-I-N-S,” on the twentieth (20^{th}) spin, the player is awarded a “Free Games Bonus” with a “+1 Free Spin” and/or “+2 Free Spin” added to a symbol position within matrix 902, and the player is awarded the number of free spins displayed on the final twentieth (20^{th}) spin. In some embodiments, the location of COR symbol(s), the wild symbol(s), the free spin symbol(s) are fixed on a reel within matrix 902. Therefore, these symbols may remain on the reel within matrix 902 during “bonus” spins. In some embodiments, if the letter symbols landed on over nineteen (19) spins spell out “R-O-W-S,” on the twentieth (20^{th}) spin, the player will be awarded a “Free Games Bonus” with two (2) additional rows added to matrix 902. In some embodiments, the additional rows added to matrix 902 may remain during any subsequent bonus spins.

Additionally, or alternatively, in some embodiments, the letter symbols landed on over a number of spins may spell out “G-R-A-N-D”, “M-A-J-O-R”, “M-I-N-O-R”, and/or “M-I-N-I”. If the letter symbols landed on over a number of spins spells out “G-R-A-N-D”, the grand prize 970 is awarded over one or more spins. Similarly, if the letter symbols landed on over a number of spins spells out “M-A-J-O-R”, major prize 972 is awarded over one or more spins, if the letter symbols landed on over a number of spins spells out “M-I-N-O-R”, minor prize 974 is awarded over one or more spins, and if the letter symbols landed on over a number of spins spells out “M-I-N-I”, mini prize 976 is awarded over one or more spins.

Additionally, or alternatively, in some embodiments, the letter symbols landed on over a number of spins may spell out a numerical value, such as “F-I-F-T-Y” and the player may be awarded a credit value associated with the numerical value over one or more spins. For example, if the letter symbols landed on over a number of spins spells out “F-I-F-T-Y”, the player may be awarded fifty credits over one or more spins.

In some embodiments, letter symbols landed on over a number of spins spells out words sequentially (e.g., spell out “P-R-I-Z-E-S” first, then “R-O-W-S”, etc.). In other embodiments, letter symbols landed on over a number of spins are collected and eventually spell one or more words (e.g., letters are collected in the following order: S, S, E, P, R, R, O, W, I, Z to spell “P-R-I-Z-E-S” and “R-O-W-S”).

In some embodiments, multiple players may participate in the fourth example game. The players may comprise one or more human players and optionally, one or more bot players, as described above. Each of the players may play the fourth example game, and game controller 202 tracks the letter symbols landed on each spin by each individual player of the group of players. Stated another way, players may work together to collect letter symbols. The letters collected by the group and/or one or more players of the group may be displayed on each player's display. A credit value, enhancement, bonus game, or the like, may be awarded upon the collected letter symbols spelling out one or more words, as described above.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

1. An electronic gaming system comprising:
at least one memory with instructions stored thereon; and
at least one processor in communication with the at least one memory, wherein the instructions, when executed by the at least one processor, cause the at least one processor to:
cause display of an electronic game, wherein the electronic game comprises a first display area comprising a plurality of active positions used for evaluation in a play of the electronic game and a second display area comprising a plurality of inactive positions not used for evaluation in the play of the electronic game;
cause display of a plurality of symbols in the first display area for the play of the electronic game;
based on a trigger symbol being included in the plurality of symbols; cause a position of the plurality of inactive positions to be activated to an activated position; and
cause the activated position to be used for evaluation in a subsequent play of the electronic game.

2. The electronic gaming system of claim 1, wherein the first display area comprises a first number of reels and the second display area comprises a second number of reels, and wherein the instructions further cause the at least one processor to:
determine that the trigger symbol is included in a first reel, wherein the first reel is included in the first number of reels;
identify a second reel that corresponds to the first reel, wherein the second reel is included in the second number of reels; and
based on the trigger symbol being included in the first reel and the first reel corresponding to the second reel:
cause the position to be activated to the activated position, wherein the position is included in the second reel; and
cause display of an animation associated with the second reel to indicate that the position has been activated to the activated position in the second reel.

3. The electronic gaming system of claim 1, wherein the instructions further cause the at least one processor to at least one of cause display of the electronic game, cause display of the plurality of symbols, cause the position of the plurality of inactive positions to be activated, or cause the activated position to be used for evaluation in the subsequent play by transmitting at least one message to a gaming device.

4. The electronic gaming system of claim 1, wherein the instructions further cause the at least one processor to at least one of cause display of the electronic game, cause display of the plurality of symbols, cause the position of the plurality of inactive positions to be activated, or cause the activated position to be used for evaluation in the subsequent play based on receiving at least one message from a server.

5. The electronic gaming system of claim 1, wherein the instructions further cause the at least one processor to cause display of the trigger symbol in the position of the plurality of inactive positions.

6. The electronic gaming system of claim 5, wherein the second display area includes at least one row, and wherein the instructions further cause the processor to, in response to determining that the trigger symbol is displayed in each position of the at least one row, cause each position of the at least one row to be activated.

7. The electronic gaming system of claim 1, wherein the instructions further cause the at least one processor to cause the trigger symbol to be replaced in the first display area.

8. The electronic gaming system of claim 1, wherein the second display area includes at least one column, the at least one column being associated with a corresponding symbol, and wherein the instructions further cause the processor to, in response to determining that each position of the at least one column is activated, cause symbols displayed in the first display area that match the corresponding symbol of the at least one column to be replaced with the trigger symbol.

9. A method performed by an electronic gaming device including at least one processor in communication with at least one memory, the method comprising:
causing display of an electronic game, wherein the electronic game includes a first display area comprising a plurality of active positions used for evaluation in a play of the electronic game and a second display area including a plurality of inactive positions not used for evaluation in the play of the electronic game;
causing display of a plurality of symbols in the first display area for the play of the electronic game;
based on a trigger symbol being included in the plurality of symbols; causing a position of the plurality of inactive positions to be activated to an activated position; and
causing the activated position to be used for evaluation in a subsequent play of the electronic game.

10. The method of claim 9, wherein the first display area includes a first number of reels and the second display area includes a second number of reels, and wherein the method further comprises:
determining that the trigger symbol is included in a first reel, wherein the first reel is included in the first number of reels;
identifying a second reel that corresponds to the first reel, wherein the second reel is included in the second number of reels; and
based on the trigger symbol being included in the first reel and the first reel corresponding to the second reel:
causing the position to be activated to the activated position, wherein the position is included in the second reel; and
causing display of an animation associated with the second reel to indicate that the position has been activated to the activated position in the second reel.

11. The method of claim 9, further comprising at least one of causing display of the electronic game, causing display of the plurality of symbols, causing the position of the plurality of inactive positions to be activated, or causing the activated position to be used for evaluation in the subsequent play by transmitting at least one message to a gaming device.

12. The method of claim 9, further comprising at least one of displaying of the electronic game, causing display of the plurality of symbols, causing the position of the plurality of inactive positions to be activated, or causing the activated position to be used for evaluation in the subsequent play based on receiving at least one message from a server.

13. The method of claim 9, further comprising causing display of the trigger symbol in the position of the plurality of inactive positions.

14. The method of claim 13, wherein the second display area includes at least one row, and wherein the method further comprises, in response to determining that the trigger symbol is displayed in each position of the at least one row, causing each position of the at least one row to be activated.

15. The method of claim 9, further comprising causing the trigger symbol to be replaced in the first display area.

16. The method of claim 9, wherein the second display area includes at least one column, the at least one column being associated with a corresponding symbol, and wherein the method further comprises, in response to determining that each position of the at least one column is activated, causing symbols displayed in the first display area that match the corresponding symbol of the at least one column to be replaced with the trigger symbol.

17. A non-transitory computer-readable storage medium with instructions stored thereon that, in response to execution by at least one processor, cause the at least one processor to:
cause display of an electronic game, wherein the electronic game comprises a first display area comprising a plurality of active positions used for evaluation in a play of the electronic game and a second display area comprising a plurality of inactive positions not used for evaluation in the play of the electronic game;
cause display of a plurality of symbols in the first display area for the play of the electronic game;
based on a trigger symbol being included in the plurality of symbols; cause a position of the plurality of inactive positions to be activated to an activated position; and
cause the activated position to be used for evaluation in a subsequent play of the electronic game.

18. The non-transitory computer-readable storage medium of claim 17, wherein the first display area includes a first number of reels and the second display area includes a second number of reels, and wherein the instructions further cause the at least one processor to:
determine that the trigger symbol is included in a first reel, wherein the first reel is included in the first number of reels;
identify a second reel that corresponds to the first reel, wherein the second reel is included in the second number of reels; and
based on the trigger symbol being included in the first reel and the first reel corresponding to the second reel:
cause the position to be activated to the activated position, wherein the position is included in the second reel; and
cause display of an animation associated with the second reel to indicate that the position has been activated to the activated position in the second reel.

19. The non-transitory computer-readable storage medium of claim 17, wherein the instructions further cause the at least one processor to at least one of cause display of the electronic game, cause display of the plurality of symbols, cause the position of the plurality of inactive positions to be activated, or cause the activated position to be used for evaluation in the subsequent play by transmitting at least one message to a gaming device.

20. The non-transitory computer-readable storage medium of claim 17, wherein the instructions further cause the at least one processor to at least one of cause display of the electronic game, cause display of the plurality of symbols, cause the position of the plurality of inactive positions to be activated, or cause the activated position to be used for evaluation in the subsequent play based on receiving at least one message from a server.
